(19) United States
(12) Patent Application Publication
(10) Pub. No.: US 2025/0218691 A1
(43) Pub. Date: Jul. 3, 2025

(54) MULTILAYER CERAMIC CAPACITOR

(71) Applicant: Murata Manufacturing Co., Ltd., Nagaokakyo-shi (JP)

(72) Inventors: Shinichi HIKIDA, Nagaokakyo-shi (JP); Tatsunori YASUDA, Nagaokakyo-shi (JP); Kazuki KUROKAWA, Nagaokakyo-shi (JP)

(21) Appl. No.: 19/081,304

(22) Filed: Mar. 17, 2025

Related U.S. Application Data
(63) Continuation of application No. PCT/JP2023/040243, filed on Nov. 8, 2023.

(30) Foreign Application Priority Data
Jan. 30, 2023 (JP) 2023-012053

(51) Int. Cl. H01G 4/30

(52) U.S. Cl. CPC H01G 4/30

(57) ABSTRACT

A multilayer ceramic capacitor includes a multilayer body and outer electrodes on two surfaces of the multilayer body. The multilayer body includes an inner-layer portion and two outer-layer portions. The inner-layer portion includes first dielectric layers laminated in the lamination direction and a first inner electrode between the first dielectric layers. Each outer-layer portion includes at least one second dielectric layer and a second inner electrode in contact with the at least one second dielectric layer. A length of the second inner electrode is less than a length of the first inner electrode, or a width of the second inner electrode is less than a width of the first inner electrode. When each outer-layer portion is divided into two equal regions, a porosity of a region near the inner-layer portion is less than a porosity of a region farther from the inner-layer portion.

### CROSS REFERENCE TO RELATED APPLICATIONS

This application claims the benefit of priority to Japanese Patent Application No. 2023-012053 filed on Jan. 30, 2023 and is a Continuation application of PCT Application No. PCT/JP2023/040243 filed on Nov. 8, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, the improvement of reliability of multilayer ceramic capacitors for vehicles and for electronic devices has been demanded.

Meanwhile, downsizing of a multilayer ceramic capacitor mounted in an electronic device may also be demanded to reduce the size of the electronic device. The downsized multilayer ceramic capacitor may be susceptible to the occurrence of cracks when the multilayer ceramic capacitor is subjected to stresses.

Japanese Unexamined Patent Application Publication No. 2019-16781 describes a technique of disposing a conductive-resin layer on an intermediate layer of an outer electrode of a multilayer ceramic capacitor. The conductive-resin layer can relax stresses and thereby reduce the occurrence of cracks in the multilayer ceramic capacitor. The conductive-resin layer also can provide reliable moisture resistance.

The multilayer ceramic capacitor disclosed in Japanese Unexamined Patent Application Publication No. 2019-16781, however, still needs improvement in order to reduce the occurrence of cracks and also to reduce the size of the multilayer ceramic capacitor.

### SUMMARY OF THE INVENTION

Example embodiments of the present invention provide multilayer ceramic capacitors that are each able to reduce or prevent an occurrence of cracks and also to reduce the size thereof.

A multilayer ceramic capacitor according to an example embodiment of the present invention includes a multilayer body including a first principal surface and a second principal surface opposed to each other in a lamination direction, a first side surface and a second side surface opposed to each other in a width direction that orthogonally or substantially orthogonally intersects the lamination direction, and a first end surface and a second end surface opposed to each other in a length direction that orthogonally or substantially orthogonally intersects the lamination direction and the width direction. The multilayer ceramic capacitor also includes at least two outer electrodes on at least two surfaces of the multilayer body. The multilayer body includes an inner-layer portion and two outer-layer portions between which the inner-layer portion is interposed in the lamination direction. The inner-layer portion includes multiple first dielectric layers laminated in the lamination direction and a first inner electrode between two of the multiple first dielectric layers and exposed at at least one of the first side surface, the second side surface, the first end surface, and the second end surface. Each outer-layer portion includes at least one second dielectric layer and a second inner electrode in contact with the at least one second dielectric layer and exposed at at least one of the first side surface, the second side surface, the first end surface, and the second end surface. A length of the second inner electrode in the length direction is less than a length of the first inner electrode in the length direction, or a width of the second inner electrode in the width direction is less than a width of the first inner electrode in the width direction. When each outer-layer portion is divided into two equal regions in the lamination direction, a porosity of a region near the inner-layer portion is smaller than a porosity of a region farther from the inner-layer portion.

According to example embodiments of the present invention, multilayer ceramic capacitors are each able to reduce or prevent an occurrence of cracks and also to reduce the size thereof.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a multilayer ceramic capacitor according to a first example embodiment of the present invention.

FIG. 2 is a cross-sectional view taken along line II-II in FIG. 1.

FIG. 3 is a cross-sectional view taken along line III-III in FIG. 1.

FIG. 4 is an exploded perspective view illustrating an inner-layer portion according to the first example embodiment of the present invention.

FIG. 5 is an enlarged view illustrating region R in FIG. 2.

FIG. 6 is a cross-sectional view of a multilayer ceramic capacitor according to a variation of the first example embodiment of the present invention, the cross-sectional view being similar to that of FIG. 1.

FIG. 7 is a perspective view illustrating a multilayer ceramic capacitor according to a second example embodiment of the present invention.

FIG. 8 is a cross-sectional view taken along line VII-VII in FIG. 7.

FIG. 9 is an exploded perspective view illustrating an inner-layer portion according to the second example embodiment of the present invention.

FIG. 10 is a perspective view illustrating a multilayer ceramic capacitor according to a third example embodiment of the present invention.

FIG. 11 is a cross-sectional view taken along line XI-XI in FIG. 10.

FIG. 12 is an exploded perspective view illustrating an inner-layer portion according to the third example embodiment of the present invention.

FIG. 13 is an exploded perspective view illustrating an inner-layer portion according to a variation of the third example embodiment of the present invention.

FIG. 14 is a flowchart illustrating an example of a method of manufacturing the multilayer ceramic capacitor of the first example embodiment of the present invention.

### DETAILED DESCRIPTION OF THE EXAMPLE EMBODIMENTS

Example embodiments of the present invention will be described in detail below with reference to the drawings.

The example embodiments described herein are examples and are not intended to limit the scope of the present invention. In addition, configurations described in different example embodiments may be combined, and resulting combinations are also within the scope of the present invention. The drawings are provided for the purpose of better understanding of the specification. Figures may be drawn schematically, and the scaling of the elements drawn therein or the scaling therebetween does not necessarily reflect what are described in the specification. In addition, elements described in the specification may be omitted in the drawings, and the number of individual elements may be different from what is described in the specification.

### 1. Multilayer Ceramic Capacitor

### First Example Embodiment

The following describes a multilayer ceramic capacitor according to a first example embodiment of the present invention.

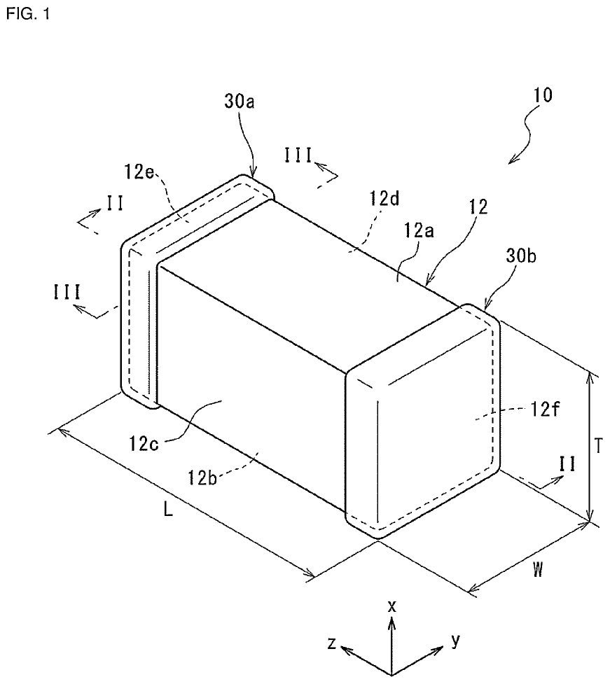

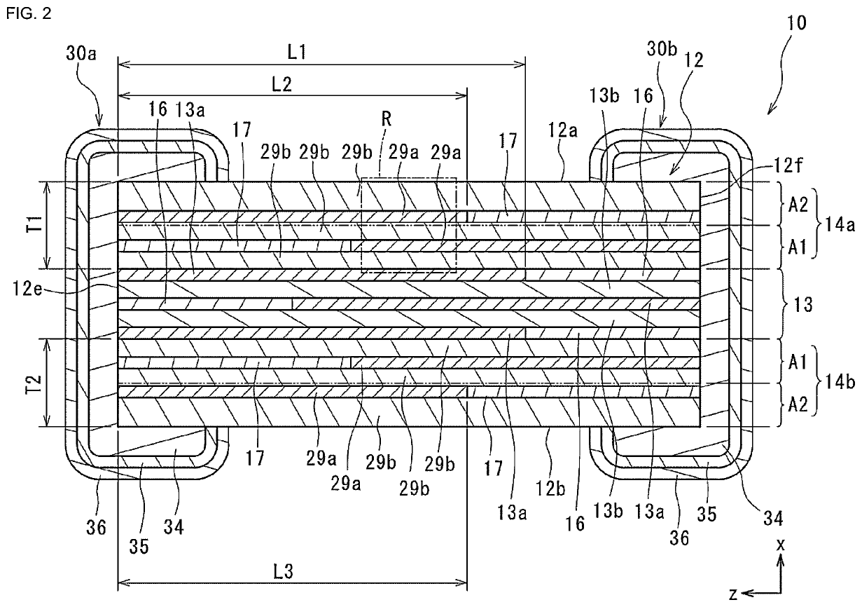

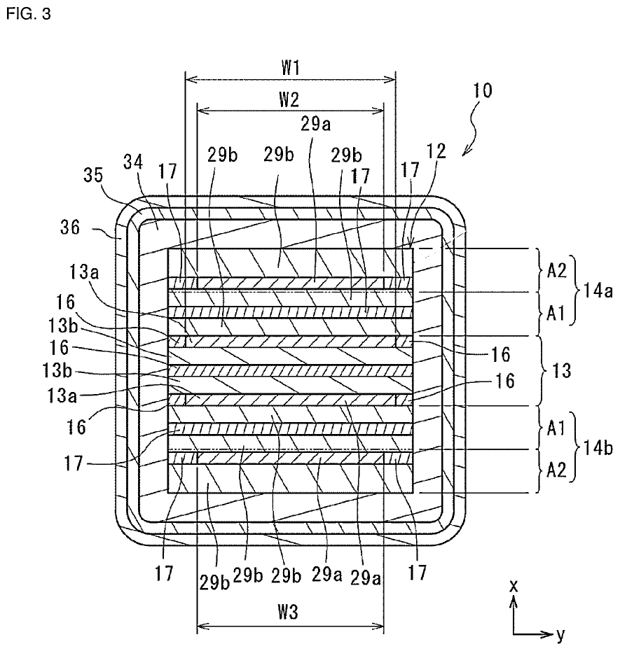

FIG. 1 is a perspective view illustrating an example of the multilayer ceramic capacitor of the first example embodiment of the present invention. FIG. 2 is a cross-sectional view taken along line II-II in FIG. 1. FIG. 3 is a cross-sectional view taken along line III-III in FIG. 1.

The lamination direction X, the width direction Y, and the length direction Z of a multilayer ceramic capacitor 10 may be indicated in the drawings, and the following description may refer to these directions.

Referring to FIG. 1, the multilayer ceramic capacitor 10 includes a multilayer body 12, a first outer electrode 30a, and a second outer electrode 30b. When it is not necessary to differentiate the first outer electrode 30a and the second outer electrode 30b from each other, these outer electrodes may be referred to simply as “outer electrodes 30”.

The multilayer body 12 of the present example embodiment has a cuboid or substantially cuboid shape. The multilayer body 12 includes a first principal surface 12a and a second principal surface 12b that are opposed to each other in the lamination direction X and a first side surface 12c and a second side surface 12d that are opposed to each other in the width direction Y. The multilayer body 12 also includes a first end surface 12e and a second end surface 12f that are opposed to each other in the length direction Z. In the present example embodiment, the lamination direction X, the width direction Y, and the length direction Z orthogonally or substantially orthogonally intersect each other. It is preferable that the vertexes and ridges of multilayer body 12 are rounded. The vertexes are portions at which adjacent three surfaces of the multilayer body 12 intersect. The ridges are portions at which adjacent two surfaces of the multilayer body 12 intersect. Recesses and protrusions may be provided on a portion of, or on the entirety of, the first principal surface 12a, the second principal surface 12b, the first side surface 12c, the second side surface 12d, the first end surface 12e, and the second end surface 12f.

As illustrated in FIGS. 2 and 3, the multilayer body 12 includes an inner-layer portion 13, a first outer-layer portion 14a, and a second outer-layer portion 14b. In the following description, the first outer-layer portion 14a and the second outer-layer portion 14b may be referred to simply as “outer-layer portions 14”.

### Inner-Layer Portion

The inner-layer portion 13 includes multiple first inner electrodes 13a and multiple first dielectric layers 13b. The inner-layer portion 13 extends from the first inner electrode 13a positioned closest to the first outer-layer portion 14a to the first inner electrode 13a positioned closest to the second outer-layer portion 14b. In other words, the inner-layer portion 13 is a portion between the first inner electrode 13a adjoining the first outer-layer portion 14a and the first inner electrode 13a adjoining the second outer-layer portion 14b with both first inner electrodes 13a being included.

The first dielectric layers 13b are laminated in the lamination direction X. The material of each of the first dielectric layers 13b is not specifically limited. For example, a dielectric ceramic material including BaTiO₃ as a main ingredient may be used as the material of the first dielectric layer 13b. More specifically, for example, the material of the first dielectric layer 13b may include crystal grains including a perovskite compound with a basic structure of BaTiO₃. The dielectric ceramic material of the first dielectric layer 13b may include a compound other than BaTiO₃, such as, for example, CaTiO₃, SrTiO₃, or CaZrO₃, as the main ingredient. In addition to the main ingredient, such as BaTiO₃, CaTiO₃, SrTiO₃, or CaZrO₃, the material of the first dielectric layer 13b may include, for example, a secondary ingredient, such as a Mn-compound, an Fe-compound, a Cr-compound, a Co-compound, or a Ni-compound, with the content of the secondary ingredient being smaller than that of the main ingredient. The thickness of the first dielectric layer 13b, which is the dimension in the lamination direction X, is not specifically limited but is preferably about 10.0 μm or less, for example.

In the lamination direction X, each first inner electrode 13a is disposed between two adjacent dielectric layers included in the multilayer body 12. In the lamination direction X, a first inner electrode 13a may be disposed between two adjacent first dielectric layers 13b. In the lamination direction X, a first inner electrode 13a may be disposed between a first dielectric layer 13b and a second dielectric layer 29b of each outer-layer portion 14 such that the second dielectric layer 29b adjoins the first dielectric layer 13b. A first dielectric layer 13b is disposed between two adjacent first inner electrodes 13a in the lamination direction X. Each first inner electrode 13a is in contact with the corresponding first dielectric layer 13b.

The first inner electrodes 13a of the present example embodiment are tabular electrodes. The first inner electrodes 13a extend in the length direction Z. Each of the first inner electrodes 13a includes a first end portion exposed at the first end surface 12e or at the second end surface 12f and a second end portion positioned inside the multilayer body 12.

In the present example embodiment, as illustrated in FIG. 2, each of the first inner electrodes 13a is exposed either at the first end surface 12e or at the second end surface 12f of the multilayer body 12. In other words, the first inner electrodes 13a include those exposed at the first end surface 12e and not exposed at the second end surface 12f and also include those exposed at the second end surface 12f and not exposed at the first end surface 12e. The first inner electrodes 13a exposed at the first end surface 12e and not exposed at the second end surface 12f and the first inner electrodes 13a exposed at the second end surface 12f and not exposed at the first end surface 12e are disposed in an alternating manner in the lamination direction X.

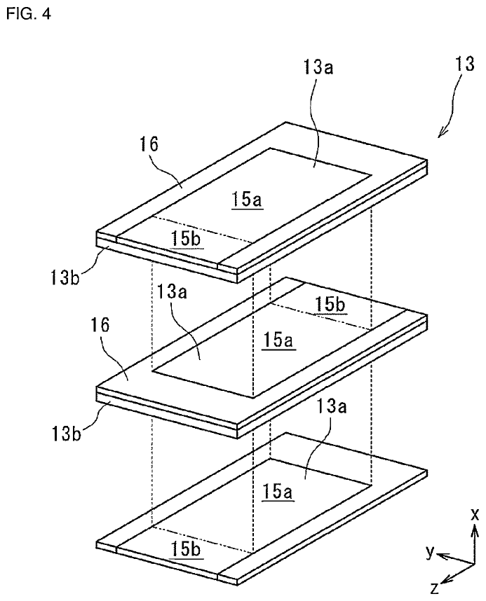

FIG. 4 is an exploded perspective view illustrating the inner-layer portion 13. As illustrated in FIG. 4, each first inner electrode 13a includes an opposing-electrode portion 15a and an extended-electrode portion 15b. The opposing-electrode portion 15a is a portion of the first inner electrode 13a that opposes an adjacent one of the first inner electrodes 13a in the lamination direction X. The extended-electrode portion 15b is a portion of the first inner electrode 13a other than the opposing-electrode portion 15a. In the lamination direction X, the opposing-electrode portions 15a of adjacent first inner electrodes 13a oppose each other with a first dielectric layer 13b interposed therebetween, thus generating electrostatic capacitance. Each extended-electrode portion 15b is exposed either at the first end surface 12e or at the second end surface 12f.

The shape of the first inner electrode 13a is not specifically limited but is, for example, preferably rectangular or substantially rectangular as viewed in the lamination direction X. The corners of the opposing-electrode portion 15a may be chamfered or rounded. The corner of the extended-electrode portion 15b may also be chamfered or rounded.

The first inner electrode 13a may have a constant thickness, in other words, a constant dimension in the lamination direction X, as it extends in the width direction Y. In the width direction Y, the thickness of an end portion of the first inner electrode 13a may be greater than that of the central portion thereof.

In the present example embodiment, the main ingredient of the first inner electrode 13a is, for example, Cu. The main ingredient of the first inner electrode 13a is not specifically limited but may be a metal other than Cu, such as, for example, Ni, Pd, or Ag. The main ingredient of the first inner electrode 13a may be an alloy of, for example, Ni, Pd, Ag, or Cu with other metals.

The thickness of the first inner electrode 13a is not specifically limited but preferably is, for example, about 0.2 μm or more and about 2.0 μm or less.

### Outer-Layer Portion

As illustrated in FIGS. 2 and 3, the first outer-layer portion 14a and the second outer-layer portion 14b are disposed with the inner-layer portion 13 being interposed therebetween in the lamination direction X. The first outer-layer portion 14a is disposed at one side (i.e., the upper side in FIGS. 2 and 3) of the inner-layer portion 13 in the lamination direction X. In other words, the first outer-layer portion 14a is disposed closer to the first principal surface 12a than the inner-layer portion 13 to the first principal surface 12a. The second outer-layer portion 14b is disposed at the other side (i.e., the lower side in FIGS. 2 and 3) of the inner-layer portion 13 in the lamination direction X. In other words, the second outer-layer portion 14b is disposed closer to the second principal surface 12b than the inner-layer portion 13 to the second principal surface 12b.

Each outer-layer portion 14 includes multiple second inner electrodes 29a and multiple second dielectric layers 29b. The number of the second inner electrodes 29a is not limited to a plurality and may be one.

The second dielectric layers 29b are laminated in the lamination direction X. The material of each of the second dielectric layers 29b is not specifically limited. For example, a dielectric ceramic material including BaTiO₃ as a main ingredient may be used as the material of the second dielectric layer 29b. The dielectric ceramic material of the second dielectric layer 29b may include a compound other than BaTiO₃, such as, for example, CaTiO₃, SrTiO₃, or CaZrO₃, as the main ingredient. In addition to the main ingredient, such as BaTiO₃, CaTiO₃, SrTiO₃, or CaZrO₃, the material of the second dielectric layer 29b may include, for example, a secondary ingredient, such as a Mn-compound, an Fe-compound, a Cr-compound, a Co-compound, or a Ni-compound, with the content of the secondary ingredient being smaller than that of the main ingredient.

The main ingredient of the second dielectric layer 29b may be different from that of the first dielectric layer 13b. In this case, it is effective, from the viewpoint of acoustic noise reduction or prevention, to use the main ingredient having a low dielectric constant for the second dielectric layer 29b compared with that for the first dielectric layer 13b, which enables a portion producing the greatest capacitance to be disposed at a position farther away from the circuit board. In the case of the second dielectric layer 29b having a smaller dielectric constant than the first dielectric layer 13b, the electrostatic capacitance generated in the inner-layer portion 13 can be made greater than that generated in the outer-layer portions 14. This enables the inner-layer portion 13 to generate the greatest electrostatic capacitance in the multilayer ceramic capacitor 10. Accordingly, when the multilayer ceramic capacitor 10 is mounted onto the circuit board, the region generating the greatest electrostatic capacitance can be positioned farther away from the circuit board compared with the case where the outer-layer portion 14 generates the greatest electrostatic capacitance. As a result, the vibration generated in the inner-layer portion 13 is not transmitted easily to the circuit board, which can reduce or prevent the production of acoustic noise caused by the vibration of the circuit board.

Each of the second inner electrodes 29a is disposed between two adjacent second dielectric layers 29b in the lamination direction X. Each second inner electrode 29a is in contact with the corresponding second dielectric layers 29b.

The second inner electrode 29a of the present example embodiment is a tabular electrode. The second inner electrode 29a extends in the length direction Z. The second inner electrode 29a includes a first end portion exposed at the first end surface 12e or at the second end surface 12f and a second end portion positioned inside the multilayer body 12.

The length of the second inner electrode 29a, which is the dimension in the length direction Z, is less than a length L1 of the first inner electrode 13a. More specifically, a length L2 of the second inner electrode 29a of the first outer-layer portion 14a is less than the length L1 of the first inner electrode 13a. In addition, a length L3 of the second inner electrode 29a of the second outer-layer portion 14b is less than the length L1 of the first inner electrode 13a.

Referring to FIG. 3, the width of the second inner electrode 29a, which is the dimension in the width direction Y, is less than a width W1 of the first inner electrode 13a. More specifically, a width W2 of the second inner electrode 29a of the first outer-layer portion 14a is less than the width W1 of the first inner electrode 13a. In addition, a width W3 of the second inner electrode 29a of the second outer-layer portion 14b is less than the width W1 of the first inner electrode 13a.

As illustrated in FIG. 2, each second inner electrode 29a is exposed either at the first end surface 12e or at the second end surface 12f of the multilayer body 12. In other words, the second inner electrodes 29a include those exposed at the first end surface 12e and not exposed at the second end surface 12f and also include those exposed at the second end surface 12f and not exposed at the first end surface 12e. The second inner electrodes 29a exposed at the first end surface 12e and not exposed at the second end surface 12f and the second inner electrodes 29a exposed at the second end surface 12f and not exposed at the first end surface 12e are disposed in an alternating manner in the lamination direction X.

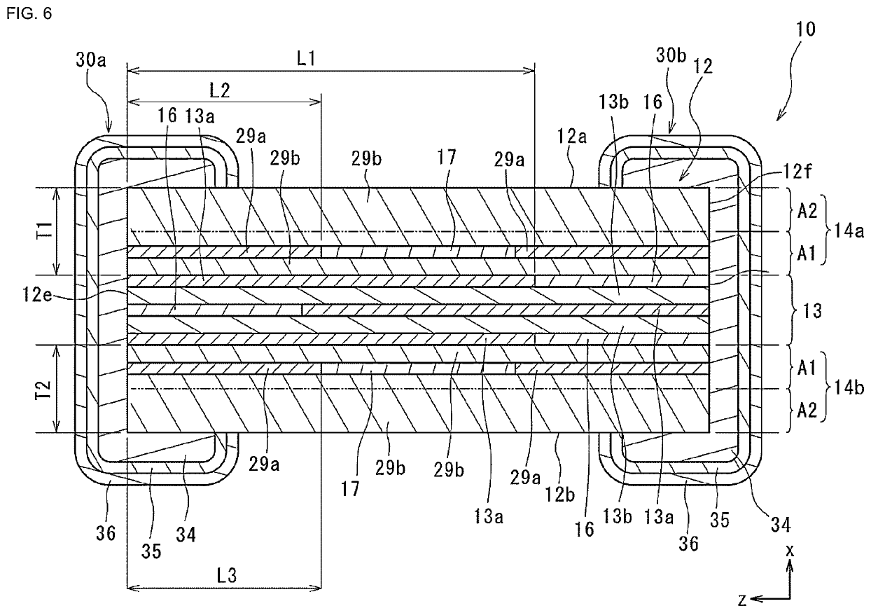

In the present example embodiment, electrostatic capacitance is generated in the outer-layer portion 14 due to the second inner electrodes 29a opposing each other with a second dielectric layer 29b being interposed therebetween. FIG. 6 illustrates an example of a variation of the present example embodiment, in which two second inner electrodes 29a are disposed without overlapping each other in the lamination direction X. As in the variation illustrated in FIG. 6, the two second inner electrodes 29a may be disposed on the same plane. The two second inner electrodes 29a may include one second inner electrode 29a of which one end portion is exposed at the first end surface 12e and the other end portion is not exposed at the second end surface 12f. The two second inner electrodes 29a may also include the other second inner electrode 29a of which one end portion is exposed at the second end surface 12f and the other end portion is not exposed at the first end surface 12e.

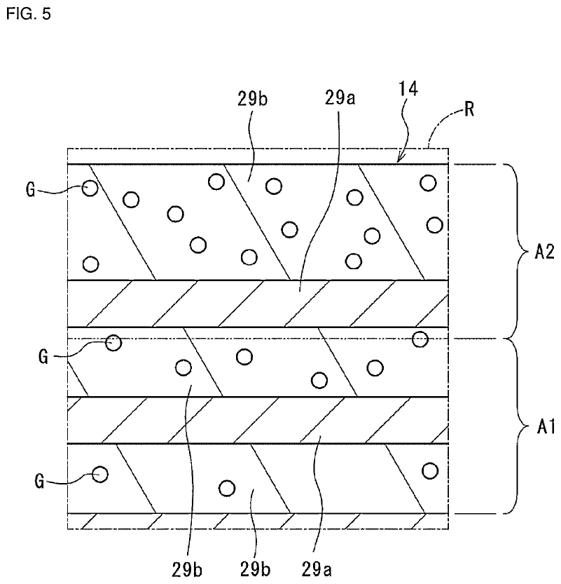

FIG. 5 is an enlarged view illustrating region R of FIG. 2. Although the following description focuses on the first outer-layer portion 14a illustrated in FIG. 5, the second outer-layer portion 14b has the same structure. As illustrated in FIG. 5, the second dielectric layers 29b of the outer-layer portion 14 include voids G. When the outer-layer portion 14 are divided into two equal portions in the lamination direction X, in other words, divided into a region A1 that is close to the inner-layer portion 13 and a region A2 that is farther from the inner-layer portion 13, the porosity of the second dielectric layers 29b in the region A1 is less than the porosity of the second dielectric layers 29b in the region A2. In other words, when the outer-layer portion 14 is divided into the two equal portions in the lamination direction X, the porosity of the second dielectric layers 29b in the region A1 that is close to the inner-layer portion 13 is less than the porosity of the second dielectric layers 29b in the region A2 that is farther from the inner-layer portion 13. For example, the porosity in the region A1 is preferably about 1% or more and about 4% or less, and the porosity in the region A2 is more than about 4% and about 10% or less. As the result of the fact that the porosity of the second dielectric layers 29b in the region A1 being close to the inner-layer portion 13 is less than that in the region A2 being farther from the inner-layer portion 13, the voids provide cushioning and relieve stress and the smaller porosity in the region close to the inner-layer portion 13 reduces the likelihood of moisture reaching the inner-layer portion 13 through the voids.

When the outer-layer portion 14 is divided into three equal portions in the lamination direction X, the porosity of the second dielectric layer 29b in the region closest to the inner-layer portion 13 is the smallest, and as the region becomes farther from the inner-layer portion 13, the porosity of the second dielectric layer 29b increases.

The following describes an example of a method of measuring the porosity of the second dielectric layer 29b. The second dielectric layers 29b are exposed at a height-length cross-section of the multilayer ceramic capacitor 10 taken at the center in the width direction Y, and the cross-section is observed using a scanning electron microscope (SEM) at a magnification of about 6000. Images were acquired at five locations within a region set to a field-of-view size of about 19.5 μm×about 10.5 μm, ensuring that the regions did not overlap. From each obtained SEM image, the porosity, defined as the ratio of the void area relative to the entire field of view, was calculated through image analysis. The average porosity across the five fields of view was then determined.

In the present example embodiment, as illustrated in FIG. 2, a height T1 of the first outer-layer portion 14a in the lamination direction X is less than a height T2 of the second outer-layer portion 14b. Accordingly, the inner-layer portion 13 that produces the greatest capacitance can be disposed at a position distant from the circuit board in the case of the second principal surface 12b defining and functioning as a mounting surface, which is effective to reduce or prevent the production of acoustic noise. The mounting surface is a surface of the multilayer body 12 that faces the circuit board when the multilayer ceramic capacitor 10 is mounted thereon.

In order to increase the capacitance of the multilayer ceramic capacitor 10, it is necessary to increase the area of each first inner electrode 13a. It is preferable that a coverage of the first inner electrode 13a in the width direction Y and in the length direction Z is about 90% or more, for example. The coverage of the first inner electrode 13a in the width direction Y and the length direction Z is defined as the ratio of the area of the first inner electrode 13a from which the area of the voids is excluded relative to the area surrounded by the edges of the first inner electrode 13a when the surface of the multilayer body 12 having the length L and the width W (see FIG. 1) is viewed in plan.

The greater the coverage of the surface of the first inner electrode 13a extending in the width direction Y and in the length direction Z, the greater the capacitance of the multilayer ceramic capacitor 10. On the other hand, when the coverage of the surface extending in the width direction Y and in the length direction Z is small, the first dielectric layers 13b that are positioned at both sides of the first inner electrode 13a in the lamination direction X are joined to each other through the voids. This increases the bonding strength between adjacent first dielectric layers 13b and reduces or prevents the occurrence of delamination.

An insulating layer (not illustrated) may be provided on the first side surface 12c and on the second side surface 12d of the multilayer body 12. When the insulating layer is provided, the insulating layer covers the interfaces between the first inner electrodes 13a and the corresponding first dielectric layers 13b, the interface between the first inner electrode 13a and the corresponding second dielectric layer 29b, and the interfaces between the second inner electrodes 29a and the corresponding second dielectric layers 29b, which can reduce the likelihood of moisture entering the multilayer body 12. It is preferable that the insulating layer include components the same as or similar to those included in the first dielectric layers 13b or in the second dielectric layers 29b. In the case of the insulating layer including the components the same as or similar to those of the first dielectric layers 13b, the adhesion between the insulating layer and the first dielectric layers 13b improves. In the case of the insulating layer including the components the same as or similar to those of the second dielectric layers 29b, the adhesion between the insulating layer and the second dielectric layers 29b improves.

The insulating layer may be joined to the first inner electrodes 13a and the second inner electrodes 29a. In this case, the surface of the insulating layer opposite to the surface thereof joined to the first inner electrodes 13a and the second inner electrodes 29a becomes the first side surface 12c and also becomes the second side surface 12d. More specifically, when the insulating layer is joined to the first inner electrodes 13a and to the second inner electrodes 29a, the surface of the insulating layer opposite to the first inner electrodes 13a and the second inner electrodes 29a defines and functions as the first side surface 12c and also defines and functions as the second side surface 12d of the multilayer body 12.

It is preferable that the insulating layer include an inner layer as the innermost layer in the width direction Y and an outer layer as the outermost layer in the width direction Y. The presence of the inner layer and the outer layer can be observed easily using an optical microscope because the inner layer and the outer layer have different sintering characteristics. In other words, a boundary is present between the inner layer and the outer layer. Multiple boundaries may be present.

The insulating layer is not limited to the above-described two-layer structure and may have a structure including three or more layers. When the insulating layer includes three layers or more, the innermost layer in the width direction Y is referred to as the inner layer, and the outermost layer in the width direction Y is referred to as the outer layer.

A step layer 16 is provided on the same surface on which each first inner electrode 13a is disposed. In the case of the step layer 16 not being provided, the thickness of the inner-layer portion 13 becomes different between the portion in which the first inner electrode 13a is provided and the portion in which the first inner electrode 13a is not provided, which may cause the distortion of the multilayer ceramic capacitor 10 during pressing in the manufacturing process (to be described later). As opposed to this, in the present example embodiment, the step layer 16 compensates for the height difference in the lamination direction X caused by providing the first inner electrode 13a, which can reduce or prevent the occurrence of distortion of the multilayer ceramic capacitor 10 during the pressing in the manufacturing process. It is preferable that the step layer 16 has the same or substantially the same thickness as that of the first inner electrode 13a provided on the same surface. It is also preferable that the step layer 16 is made of the same or substantially the same material as that of the first dielectric layer 13b. The step layer 16 may include the same or substantially the same components as those of the first inner electrode 13a provided on the same surface. In this case, the step layer 16 is disposed so as to provide a gap from the first inner electrode 13a in the width direction Y and in the length direction Z. It is necessary to isolate the step layer 16 from the first inner electrode 13a.

A step layer 17 is provided on the same surface on which each second inner electrode 29a is provided. In the case of the step layer 17 not being provided, the thickness of the outer-layer portion 14 becomes different between the portion in which the second inner electrode 29a is provided and the portion in which the second inner electrode 29a is not provided, which may cause the distortion of the multilayer ceramic capacitor 10 during the pressing in the manufacturing process (to be described later). As opposed to this, in the present example embodiment, the step layer 17 compensates for the height difference in the lamination direction X caused by providing the second inner electrode 29a, which can reduce or prevent the occurrence of distortion of the multilayer ceramic capacitor during the pressing in the manufacturing process. It is preferable that the step layer 17 has the same or substantially the same thickness as that of the second inner electrode 29a provided on the same surface. It is also preferable that the step layer 17 is made of the same or substantially the same material as that of the second dielectric layer 29b. The step layer 17 may include the same or substantially the same components as those of the second inner electrode 29a provided on the same surface. In this case, the step layer 17 is disposed so as to provide a gap from the second inner electrode 29a in the width direction Y and in the length direction Z. It is necessary to isolate the step layer 17 from the second inner electrode 29a.

A gap region refers to a region between the first inner electrode 13a and the first end surface 12e and a region between the first inner electrode 13a and the second end surface 12f. In the case of the step layer 16 and the step layer 17 not being provided, it is preferable that the second inner electrodes 29a is positioned where the gap region is translated in the lamination direction X. In other words, in the case of the step layer 16 and the step layer 17 not being provided, the second inner electrodes 29a are preferably provided at positions that do not overlap the first inner electrodes 13a when the first and second inner electrodes are viewed in the lamination direction X. This can compensate for local height differences of the multilayer body 12, in the lamination direction X, that are caused by providing the first inner electrode 13a, thus reducing or preventing the occurrence of distortion of the multilayer body 12 caused by the local height differences.

### Outer Electrode

The outer electrodes 30 are provided on the first end surface 12e and the second end surface 12f of the multilayer body 12, respectively.

The first outer electrode 30a is provided near the first end surface 12e of the multilayer body 12. It is preferable that the first outer electrode 30a is provided continuously on the first end surface 12e, the first principal surface 12a, and the second principal surface 12b of the multilayer body 12. It is more preferable that the first outer electrode 30a is also provided on the first side surface 12c and the second side surface 12d. The first outer electrode 30a is joined to the first inner electrodes 13a and the second inner electrodes 29a, both of which are exposed at the first end surface 12e of the multilayer body 12. Accordingly, the first outer electrode 30a is electrically connected to the first inner electrodes 13a and the second inner electrodes 29a exposed at the first end surface 12e of the multilayer body 12.

The second outer electrode 30b is provided near the second end surface 12f of the multilayer body 12. It is preferable that the second outer electrode 30b is provided continuously on the second end surface 12f, the first principal surface 12a, and the second principal surface 12b of the multilayer body 12. It is more preferable that the second outer electrode 30b is also provided on the first side surface 12c and the second side surface 12d. The second outer electrode 30b is joined to the first inner electrodes 13a and the second inner electrodes 29a, both of which are exposed at the second end surface 12f of the multilayer body 12. Accordingly, the second outer electrode 30b is electrically connected to the first inner electrodes 13a and the second inner electrodes 29a exposed at the second end surface 12f of the multilayer body 12.

As illustrated in FIG. 2, each outer electrode 30 includes a base-electrode layer 34, an under-plating layer 35, and a surface-plating layer 36. The base-electrode layer 34 includes a conductive metal and is disposed on the multilayer body 12. The under-plating layer 35 covers the surface of the base-electrode layer 34, and the surface-plating layer 36 covers the surface of the under-plating layer 35. In the present example embodiment, for example, the under-plating layer 35 is a Ni-plating layer, and the surface-plating layer 36 is a Sn-plating layer.

The base-electrode layer 34 of the first outer electrode 30a is provided at the first end surface 12e of the multilayer body 12. It is preferable that the base-electrode layer 34 of the first outer electrode 30a is provided continuously on the first end surface 12e, the first principal surface 12a, and the second principal surface 12b of the multilayer body 12. It is more preferable that the base-electrode layer 34 of the first outer electrode 30a is also provided on the first side surface 12c and the second side surface 12d. The base-electrode layer 34 of the first outer electrode 30a is joined to the first inner electrodes 13a and the second inner electrodes 29a, both of which are exposed at the first end surface 12e of the multilayer body 12. Accordingly, the base-electrode layer 34 of the first outer electrode 30a is electrically connected to the first inner electrodes 13a and the second inner electrodes 29a exposed at the first end surface 12e of the multilayer body 12.

The base-electrode layer 34 of the second outer electrode 30b is provided at the second end surface 12f of the multilayer body 12. It is preferable that the base-electrode layer 34 of the second outer electrode 30b is provided continuously on the second end surface 12f, the first principal surface 12a, and the second principal surface 12b of the multilayer body 12. It is more preferable that the base-electrode layer 34 of the second outer electrode 30b is also provided on the first side surface 12c and the second side surface 12d. The base-electrode layer 34 of the second outer electrode 30b is joined to the first inner electrodes 13a and the second inner electrodes 29a, both of which are exposed at the second end surface 12f of the multilayer body 12. Accordingly, the base-electrode layer 34 of the second outer electrode 30b is electrically connected to the first inner electrodes 13a and the second inner electrodes 29a exposed at the second end surface 12f of the multilayer body 12. [0072]: The base-electrode layer 34 includes at least one of a sintering layer or a conductive-resin layer.

### In the Case of Sintering Layer

The sintering layer includes a glass component and a metal. The glass component includes at least one of, for example, B, Si, Ba, Mg, Al, or Li. The sintering layer includes at least one metal of, for example, Cu, Ni, Ag, Pd, Ag—Ni alloy, or Au. The sintering layer may include components the same as or similar to those of the first dielectric layer 13b in place of the glass component.

### In the Case of Conductive-Resin Layer

The conductive-resin layer may cover the sintering layer or may be provided directly on the multilayer body 12.

The conductive-resin layer includes a thermosetting resin and a metal. The conductive-resin layer including the thermosetting resin is more flexible compared with conductive layers made of, for example, a plated film or a sintering product of a conductive paste. Accordingly, even in the case of the multilayer ceramic capacitor 10 receiving a physical impact or an impact induced by heat cycling, the conductive-resin layer defines and functions as a buffer layer and thus reduces or prevents the generation of cracks in the multilayer ceramic capacitor 10.

The metal included in the conductive-resin layer may be, for example, Ag, Cu, or an alloy thereof. The metal included in the conductive-resin layer may be, for example, a metal powder of which the particles are coated with Ag. The metal powder of Ag-coated particles is preferably made of, for example, Cu or Ni. Cu particles treated for antioxidation may be used as the metal included in the conductive-resin layer.

A Ag powder is used for the conductive metal because Ag has the smallest specific resistance among metals and is thereby suitable for the electrode material and Ag is an oxidation-resistant noble metal with a high weather resistance. The Ag-coated metal powder is used in order to utilize a cheap base metal while the surface coating provides the above characteristics of Ag.

The metal included in the conductive-resin layer defines and functions mainly to provide electric conductivity. More specifically, the conductive filler particles included in the conductive-resin layer come into contact with one another, thus providing conductive paths inside the conductive-resin layer.

Metal particles included in the conductive-resin layer may have, for example, a spherical or flat shape but are preferably made of a mixture of spherical particles with flat ones.

For example, the resin included in the conductive-resin layer may be a known thermosetting resin, such as epoxy resin, phenolic resin, urethane resin, silicone resin, or polyimide resin. The epoxy resin is one of the suitable resins for the conductive-resin layer because the epoxy resin is superior in thermal resistance, moisture resistance, and adhesion.

The conductive-resin layer preferably includes a hardening agent in addition to the thermosetting resin. When the epoxy resin is used as the base resin, the hardening agent used for the epoxy resin may be a known compound, such as a phenol-based, amin-based, acid-anhydride-based, or imidazole-based compound, for example.

### Advantageous Effects

The multilayer ceramic capacitor 10 of the present example embodiment can provide advantageous effects as follows.

When the outer-layer portion 14 is divided into two equal portions in the lamination direction X, the porosity of the second dielectric layers 29b in the region A1 that is close to the inner-layer portion 13 is less than the porosity of the second dielectric layers 29b in the region A2 that is farther from the inner-layer portion 13. With this configuration, when internal stresses are generated in the outer-layer portion 14, the region A2 having a higher porosity can relax the stresses and thus reduce or prevent the occurrence of cracks.

This eliminates the necessity of providing a member to reinforce the multilayer body 12 that is structured as above and can reduce or prevent the occurrence of cracks. As a result, the size of the multilayer ceramic capacitor 10 can be reduced compared with the case of the multilayer ceramic capacitor 10 being provided with a separate member to reinforce the multilayer body 12.

In the case of moisture entering the voids G in the outer-layer portion 14, the second dielectric layer 29b in the region A1 closer to the inner-layer portion 13 can reduce the likelihood of the moisture reaching the inner-layer portion 13 through the voids G because the porosity of the second dielectric layer 29b in the region A1 is relatively small. This leads to an improvement in the moisture resistance of the multilayer ceramic capacitor 10.

In the lamination direction X, the height T2 of the second outer-layer portion 14b closer to the second principal surface 12b is greater than the height T1 of the first outer-layer portion 14a closer to the first principal surface 12a. With this configuration, when the second principal surface 12b defines and functions as the mounting surface, the inner-layer portion 13 is positioned farther from the mounting surface compared with the case of the first principal surface 12a defining and functioning as the mounting surface. As a result, the vibration generated in the inner-layer portion 13, which produces the greatest capacitance in the multilayer body 12, is not transmitted easily to the circuit board, which can reduce or prevent the production of acoustic noise caused by the vibration of the circuit board.

The length L3 of the second inner electrode 29a in the second outer-layer portion 14b, which is closer to the second principal surface 12b, is less than the length L2 of the second inner electrode 29a in the first outer-layer portion 14a, which is closer to the first principal surface 12a. With this configuration, the capacitance produced in the second outer-layer portion 14b is made smaller than that produced in the first outer-layer portion 14a. Accordingly, when the second principal surface 12b defines and functions as the mounting surface, the vibration transmitted to the circuit board can be reduced compared with the case of the first principal surface 12a defining and functioning as the mounting surface. As a result, the occurrence of acoustic noise caused by the vibration of the circuit board can be reduced or prevented.

In the present example embodiment, the first inner electrodes 13a are exposed either at the first end surface 12e or at the second end surface 12f. The first inner electrodes 13a, however, may be exposed either at the first side surface 12c or at the second side surface 12d. In the present example embodiment, the second inner electrodes 29a are exposed either at the first end surface 12e or at the second end surface 12f. The second inner electrodes 29a, however, may be exposed either at the first side surface 12c or at the second side surface 12d.

In the present example embodiment, the length L1 of the first inner electrode 13a is greater than any of the lengths L2 and L3 of the corresponding second inner electrodes 29a, and the width W1 of the first inner electrode 13a is greater than any of the widths W2 and W3 of the corresponding second inner electrodes 29a. However, when the length L1 of the first inner electrode 13a is greater than any of the lengths L2 and L3 of the corresponding second inner electrodes 29a, the width W1 of the first inner electrode 13a may be less than any of the widths W2 and W3 of the corresponding second inner electrodes 29a. When the width W1 of the first inner electrode 13a is greater than any of the widths W2 and W3 of the corresponding second inner electrodes 29a, the length Li of the first inner electrode 13a may be less than any of the lengths L2 and L3 of the corresponding second inner electrodes 29a.

### Second Example Embodiment

The following describes a multilayer ceramic capacitor according to a second example embodiment of the present invention. The multilayer ceramic capacitor of the second example embodiment has the same or substantially the same structure as that of the multilayer ceramic capacitor of the first example embodiment except for the shapes and the arrangement of the first inner electrodes, the shapes and the arrangement of the second inner electrodes, the number and the structures of the outer electrodes, and surface electrodes provided on surfaces of the multilayer body. In the second example embodiment, the elements the same as or similar to those of the first example embodiment are denoted by the same or similar reference signs as those used in the first example embodiment, and detailed descriptions will not be repeated.

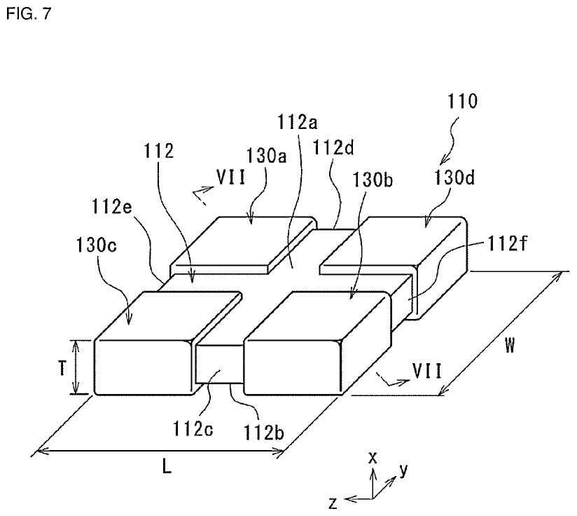

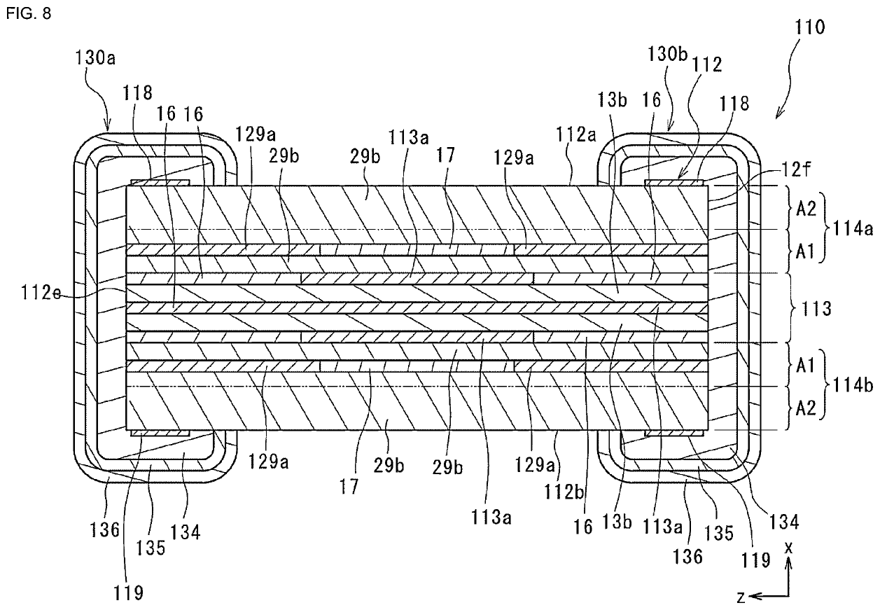

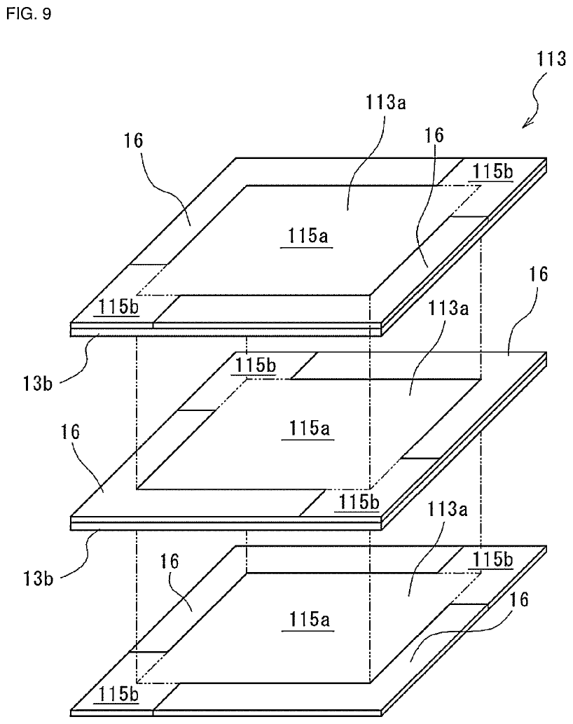

FIG. 7 is a perspective view illustrating a multilayer ceramic capacitor 110 according to the present example embodiment. FIG. 8 is a cross-sectional view taken along line VII-VII in FIG. 7. FIG. 9 is an exploded perspective view illustrating an inner-layer portion 113 according to the present example embodiment.

Referring to FIG. 7, the multilayer ceramic capacitor 110 of the present example embodiment includes a multilayer body 112 and four outer electrodes 130a, 130b, 130c, and 130d. When it is not necessary to differentiate the four outer electrodes 130a, 130b, 130c, and 130d from each other in the following description, one of the four outer electrodes 130a, 130b, 130c, and 130d may be referred to simply as an “outer electrode 130”.

When the multilayer body 112 is viewed in the lamination direction X, the outer electrode 130 is provided at each of four corners of the multilayer body 112. The outer electrode 130 covers a portion of a first principal surface 112a and a portion of a second principal surface 112b of the multilayer body 112 and covers a portion of either a first side surface 112c or a second side surface 112d and covers a portion of either a first end surface 112e or a second end surface 112f of the multilayer body 112. In order to decrease the size of the multilayer ceramic capacitor 110 in the lamination direction X, the outer electrode 130 may be disposed so as not to cover the first principal surface 112a nor to cover the second principal surface 112b. In this case, the outer electrode 130 has a letter L shape as viewed in the lamination direction X.

A ratio W/L, which is a ratio of the width W to the length L of the multilayer ceramic capacitor 110 of the present example embodiment, is, for example, about 0.85 or more and about 1.0 or less. In this case, the height, or the dimension in the lamination direction X, of the multilayer ceramic capacitor 110 is, for example, preferably about 120 μm or less. The ratio W/L may be smaller than about 0.85 and may be greater than about 1.0. For example, when the ratio W/L becomes smaller than about 0.85, the multilayer ceramic capacitor 110 looks more like a rectangle rather than a square as viewed in the lamination direction X.

As illustrated in FIGS. 8 and 9, each first inner electrode 113a of the present example embodiment includes two extended-electrode portions 115b. Each extended-electrode portion 115b is exposed at either the first side surface 112c or the second side surface 112d and at either the first end surface 112e or the second end surface 112f. Two adjacent first inner electrodes 113a opposing each other in the lamination direction X include respective extended-electrode portions 115b extending out at different surfaces. More specifically, in the case where one of the first inner electrodes 113a includes an extended-electrode portion 115b extending out at the first side surface 112c and at the first end surface 112e and an extended-electrode portion 115b extending out at the second side surface 12d and at the second end surface 12f, the other first inner electrode 113a includes an extended-electrode portion 115b extending out at the first side surface 12c and at the second end surface 12f and an extended-electrode portion 115b extending out at the second side surface 12d and at first end surface 12e. In the present example embodiment, as illustrated in FIG. 9, each extended-electrode portion 115b is exposed continuously from an end surface to a side surface. The extended-electrode portion 115b, however, may be exposed discontinuously at an end surface and at a side surface.

Second inner electrodes 129a are positioned where respective extended-electrode portion 115b of the first inner electrodes 113a are translated in the lamination direction X. In other words, each second inner electrode 129a is disposed at a position that overlaps the extended-electrode portion 115b of the corresponding first inner electrode 113a as viewed in the lamination direction X. In addition, two second inner electrodes 129a may be provided on the same plane. The two second inner electrodes 129a provided on the same plane are disposed so as not to overlap each other in the lamination direction X. The second inner electrodes 129a are disposed in a first outer-layer portion 114a and also in a second outer-layer portion 114b, which ensures the electric coupling between a first surface electrode 118 and the corresponding first inner electrode 113a and also between a second surface electrode 119 and the corresponding first inner electrode 113a via a base-electrode layer 134, which will be described later. The conductive component of the outer electrodes 130 is adhered to the conductive component of the second inner electrodes 129a, which can increase the adhesion between the outer electrodes 130 and the multilayer body 112.

Referring to FIG. 8, in the present example embodiment, four first surface electrodes 118 are provided on the first principal surface 112a of the multilayer body 112 (only two of them can be seen in FIG. 8). Four second surface electrodes 119 are provided on the second principal surface 112b of the multilayer body 112 (only two of them can be seen in FIG. 8). The first surface electrodes 118 are provided at four corner portions of the first principal surface 112a, respectively. The second surface electrodes 119 are provided at four corner portions of the second principal surface 112b, respectively. The first surface electrodes 118 and the second surface electrodes 119 are positioned where the extended-electrode portions 115b of the first inner electrode 113a are translated in the lamination direction X. In other words, the first surface electrodes 118 and the second surface electrodes 119 are positioned so as to overlap the extended-electrode portions 115b of the first inner electrodes 113a as viewed in the lamination direction X. The first surface electrodes 118 and the second surface electrodes 119 do not contribute to the generation of electrostatic capacitance.

Each of the first surface electrodes 118 and the second surface electrodes 119 may have the same or substantially the same shape and size as those of the second inner electrode 129a. In this case, it is preferable that the first surface electrodes 118 and the second surface electrodes 119 are made of the same material as the second inner electrodes 129a.

The first surface electrodes 118 and the second surface electrodes 119 may be formed using sputtering, for example. In the case of the first surface electrodes 118 and the second surface electrodes 119 being formed by sputtering, it is preferable that the first surface electrodes 118 and the second surface electrodes 119 include, for example, at least one of Ni, Cr, Cu, or Ti. The thickness of each of the first surface electrodes 118 and the second surface electrodes 119 formed using sputtering is, for example, preferably about 50 nm or more and about 400 nm or less. This enables the thickness of the first surface electrode 118 and of the second surface electrode 119 to be sufficiently small in the lamination direction X, which can sufficiently reduce the thickness of the multilayer ceramic capacitor 110 in the lamination direction X. The thickness of the first surface electrode 118 and the second surface electrode 119 can be adjusted by changing the distance between the target and portions to be subjected to sputtering. The thickness of the first surface electrode 118 and the second surface electrode 119 may be measured using actual observation images or may be obtained by conversion using the calibration-curve method for metal species using fluorescent X-rays and focusing on a predetermined element.

The first surface electrodes 118 and the second surface electrodes 119 may be sintered electrodes. The sintered electrodes are electrodes including the same dielectric component as that of the first dielectric layer 13b or the second dielectric layer 29b. In other words, in the case of the second dielectric layer 29b including CaZrO₃, the first surface electrodes 118 or the second surface electrodes 119 include, for example, CaZrO₃, Ca, or Zr. In the case of the second dielectric layer 29b including components different from those of the first dielectric layer 13b, it is preferable that the first surface electrodes 118 and the second surface electrodes 119 include the same components as those of the second dielectric layer 29b. This can increase the adhesion between the second dielectric layers 29b and the first and second surface electrodes 118 and 119.

It is preferable that metal components of the sintered electrode include, for example, Ni. In this case, it is preferable that the first inner electrode 113a include, for example, Ni. In the case of the sintered electrode including the metal components as those of the first inner electrode 113a, the multilayer body 112 and the first and second surface electrodes 118 and 119 can be sintered simultaneously in a step of sintering the multilayer body 112.

The sintered electrode is formed by, for example, sintering a conductive paste for Ni-sintered electrode after the conductive paste is applied onto the dielectric sheet using screen printing. If the conductive paste for Ni-sintered electrode is applied thinly or the dielectric component content in the conductive paste for Ni-sintered electrode is reduced, Ni-particles are bonded during sintering to form discontinuous sintered electrodes. In other words, by forming discontinuous sintered electrodes, the sintered electrodes are disposed in a discontinuous manner as viewed in the width direction Y.

As illustrated in FIG. 8, each outer electrode 130 includes a base-electrode layer 134, an under-plating layer 135, and a surface-plating layer 136. The base-electrode layer 134 includes a conductive metal and is disposed on the multilayer body 112. The under-plating layer 135 covers the surface of the base-electrode layer 134, and the surface-plating layer 136 covers the surface of the under-plating layer 135. In the present example embodiment, for example, the under-plating layer 135 is a Ni-plating layer, and the surface-plating layer 136 is a Sn-plating layer. Although the base-electrode layer 134, the under-plating layer 135, and the surface-plating layer 136 are disposed in this order in FIG. 8, the plating layers may be formed in the order of the base-electrode layer, the surface-plating layer, the under-plating layer, and the surface-plating layer.

The base-electrode layer 134 is preferably a direct plating layer. The direct plating layer directly covers the surface of the multilayer body 112. In the case of the base-electrode layer 134 being the direct plating layer, the thickness of the outer electrode 130 can be reduced in each direction, which leads to a reduction in the size of the multilayer ceramic capacitor. The metal content per a unit volume of the direct plating layer is, for example, preferably about 99 volume percent or more. The direct plating layer may include two layers in which the grain size of metal is different. In this case, it is preferable that the plating layer having a larger grain size of metal is disposed near the multilayer body 112 and that the plating layer having a smaller grain size of metal is disposed spaced away from the multilayer body 112.

The multilayer ceramic capacitors 110 of the second example embodiment provides advantageous effects the same as or similar to those of the multilayer ceramic capacitors 10 of the first example embodiment.

### Third Example Embodiment

The following describes a multilayer ceramic capacitor 210 according to a third example embodiment of the present invention. The multilayer ceramic capacitor 210 of the third example embodiment has the same or substantially the same structure as that of the multilayer ceramic capacitor 10 of the first example embodiment except for the overall shape. In the third example embodiment, the elements the same as or similar to those of the first example embodiment are denoted by the same or similar reference signs as those used in the first example embodiment, and detailed descriptions will not be repeated.

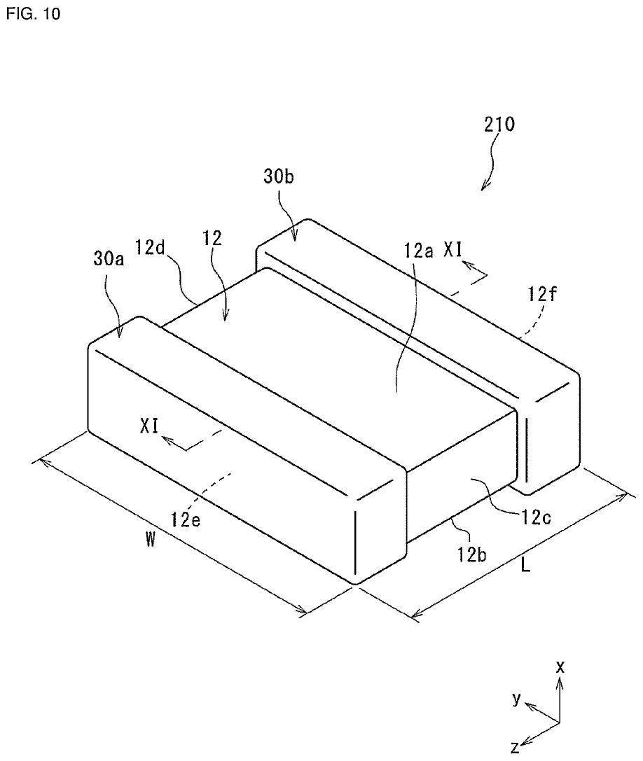

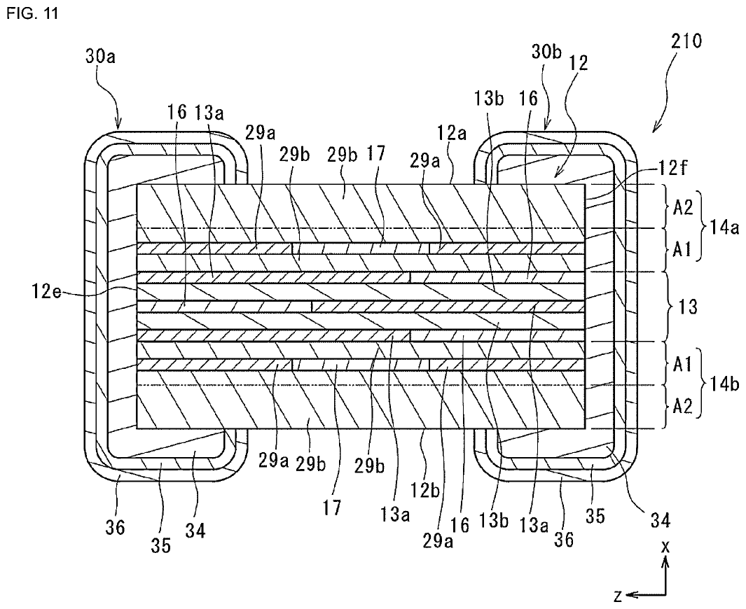

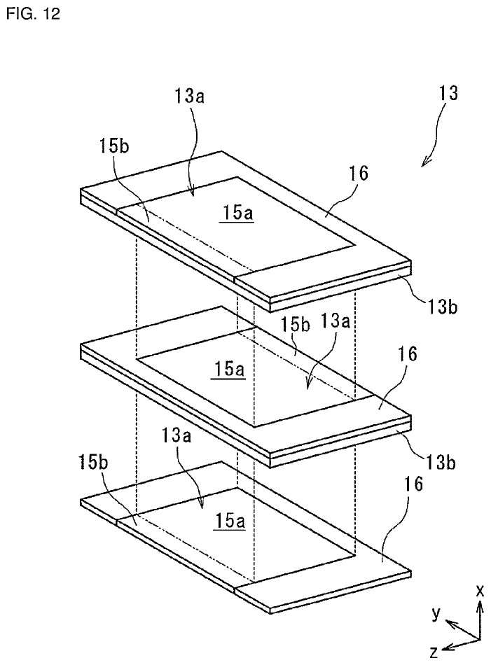

FIG. 10 is a perspective view illustrating the multilayer ceramic capacitor 210 of the present example embodiment. FIG. 11 is a cross-sectional view taken along line XI-XI in FIG. 10. FIG. 12 is an exploded perspective view illustrating the inner-layer portion 13 according to the present example embodiment.

In the present example embodiment, as illustrated in FIG. 10, the length L of the multilayer ceramic capacitor 210 is less than the width W thereof.

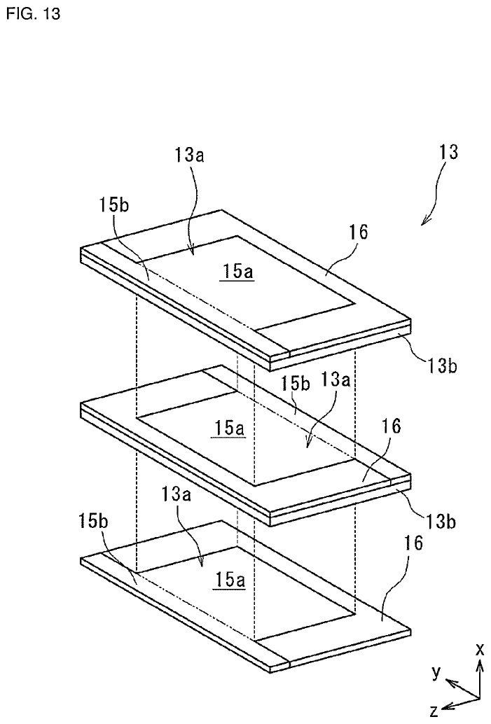

As illustrated in FIGS. 11 and 12, each first inner electrode 13a is exposed either at the first end surface 12e or at the second end surface 12f. FIG. 13 illustrates a variation of the present example embodiment. As illustrated in FIG. 13, each first inner electrode 13a may be exposed either at the first end surface 12e or at the second end surface 12f and also exposed at both of the first side surface 12c and the second side surface 12d.

The multilayer ceramic capacitors 210 of the third example embodiment provides advantageous effects the same as or similar to those of the multilayer ceramic capacitors 10 of the first example embodiment.

### 2. Method of Manufacturing Multilayer Ceramic Capacitor

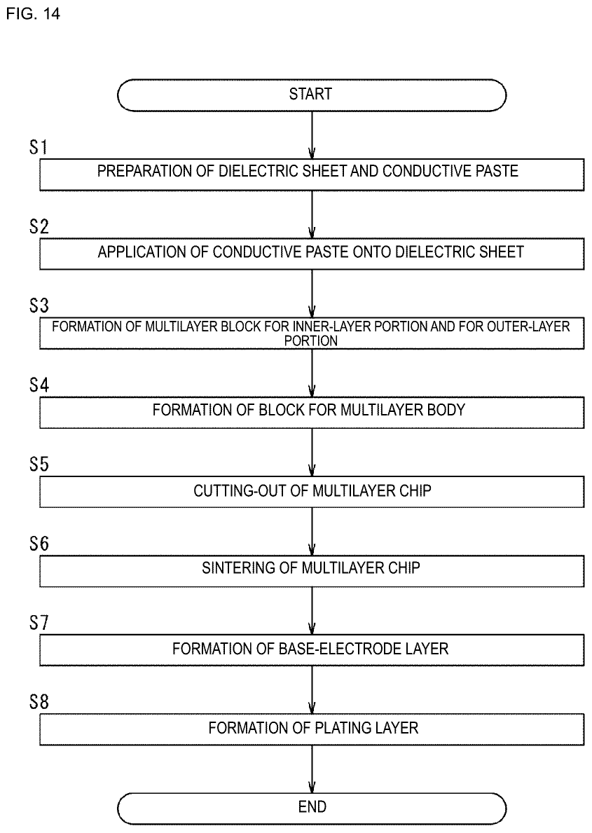

An example of a method of manufacturing multilayer ceramic capacitors will be described with reference to FIG. 14. FIG. 14 is a flowchart illustrating an example of a method of manufacturing the multilayer ceramic capacitor. The following describes a method of manufacturing the multilayer ceramic capacitor 10 of the first example embodiment by way of example. A similar method of manufacturing the multilayer ceramic capacitor 10 of the first example embodiment can be used to manufacture the multilayer ceramic capacitor 110 of the second example embodiment and the multilayer ceramic capacitor 210 of the third example embodiment. The following description focuses on the case of the base-electrode layer 34 being made of the sintering layer.

In step S1, dielectric sheets, conductive paste for inner electrode, and conductive paste for outer electrode are prepared. The dielectric sheets, the conductive paste for inner electrode, and the conductive paste for outer electrode include binder and solvent.

In step S2, a dielectric sheet for the inner-layer portion, on which an inner electrode pattern for the inner-layer portion 13 is printed, is formed by printing a predetermined pattern on a dielectric sheet using the conductive paste for inner electrode. The conductive paste for inner electrode can be applied onto the dielectric sheet using screen printing or photogravure, for example.

In step S2, a dielectric sheet for the first outer-layer portion, on which an inner electrode pattern for the first outer-layer portion 14a is printed, is also formed by printing a predetermined pattern on a dielectric sheet using the conductive paste for inner electrode. Similarly, a dielectric sheet for the second outer-layer portion, on which an inner electrode pattern for the second outer-layer portion 14b is printed, is formed by printing a predetermined pattern on a dielectric sheet using the conductive paste for inner electrode. The conductive paste for inner electrode can be applied onto the dielectric sheet using screen printing or photogravure, for example.

In step S3, a multilayer block for the inner-layer portion is formed by laminating multiple dielectric sheets for the inner-layer portion in the lamination direction and by pressing the sheets together using, for example, an isostatic press.

In step S3, a multilayer block for the first outer-layer portion is also formed by laminating multiple dielectric sheets for the first outer-layer portion in the lamination direction and by pressing the sheets together using, for example, the isostatic press. More specifically, the multilayer block for the first outer-layer portion is formed layer by layer by repeating the lamination and pressing of the dielectric sheets for the first outer-layer portion. As a result, the denseness of the dielectric sheet for the first outer-layer portion formed by lamination and pressing in an earlier stage becomes higher, while the denseness of the dielectric sheet for the first outer-layer portion formed by lamination and pressing in a later stage becomes lower. In other words, the earlier the dielectric sheet for the first outer-layer portion is laminated, the lower the porosity thereof, and the later the dielectric sheet for the first outer-layer portion is laminated, the higher the porosity thereof. Put another way, the closer to one side in the lamination direction the dielectric sheet is positioned, the lower the porosity of the dielectric sheet becomes, while the closer to the other side in the lamination direction the dielectric sheet is positioned, the higher the porosity of the dielectric sheet becomes. The amount of binder included in the dielectric sheet for the first outer-layer portion may be adjusted in order to adjust the porosity of the dielectric sheet for the first outer-layer portion. Different dielectric sheets for the first outer-layer portion having different thicknesses or different components may be prepared in order to obtain a multilayer block for the first outer-layer portion having a desired structure.

In step S3, a multilayer block for the second outer-layer portion is also formed by laminating multiple dielectric sheets for the second outer-layer portion in the lamination direction and by pressing the sheets together using, for example, the isostatic press. More specifically, the multilayer block for the second outer-layer portion is formed layer by layer by repeating the lamination and pressing of the dielectric sheets for the second outer-layer portion. As a result, the denseness of the dielectric sheet for the second outer-layer portion formed by lamination and pressing in an earlier stage becomes higher, while the denseness of the dielectric sheet for the second outer-layer portion formed by lamination and pressing in a later stage becomes lower. In other words, the earlier the dielectric sheet for the second outer-layer portion is laminated, the lower the porosity thereof, and the later the dielectric sheet for the second outer-layer portion is laminated, the higher the porosity thereof. Put another way, the closer to one side in the lamination direction the dielectric sheet is positioned, the lower the porosity of the dielectric sheet becomes, while the closer to the other side in the lamination direction the dielectric sheet is positioned, the higher the porosity of the dielectric sheet becomes. The amount of binder included in the dielectric sheet for the second outer-layer portion may be adjusted in order to adjust the porosity of the dielectric sheet for the second outer-layer portion. Different dielectric sheets for the second outer-layer portion having different thicknesses or different components may be prepared in order to obtain a multilayer block for the second outer-layer portion having a desired structure.

In step S4, the multilayer block for the first outer-layer portion, the multilayer block for the inner-layer portion, and the multilayer block for the second outer-layer portion 14b are laminated and pressed together in the lamination direction using, for example, the isostatic press to obtain a block for the multilayer body.

Here, the low-porosity region of the multilayer block for the first outer-layer portion is positioned close to the multilayer block for the inner-layer portion, while the high-porosity region of the multilayer block for the first outer-layer portion is positioned farther from the multilayer block for the inner-layer portion. Similarly, the low-porosity region of the multilayer block for the second outer-layer portion is positioned close to the multilayer block for the inner-layer portion, while the high-porosity region of the multilayer block for the second outer-layer portion is positioned farther from the multilayer block for the inner-layer portion.

In step S5, the block for the multilayer body are cut into multilayer chips having a predetermined size. The multilayer chips may be subjected to, for example, barrel polishing to round the vertexes and ridges of each chip.

In step S6, each multilayer chip is sintered to form the multilayer body 12 of the present example embodiment.

In step S7, for example, a conductive paste including a glass component and metal is applied, by dipping to the first end surface 12e and the second end surface 12f of the multilayer body 12 and is subjected to sintering, thus forming the base-electrode layers 34.

In step S8, plating layers are formed on the surface of each base-electrode layer 34. More specifically, for example, the under-plating layer 35, which is the Ni-plating layer, is formed on the base-electrode layer 34, which is the sintering layer. Subsequently, the surface-plating layer 36, which is the Sn-plating layer, is formed on the under-plating layer 35. The under-plating layer 35 and the surface-plating layer 36 may be formed using barrel plating, for example.

In the case of the base-electrode layer 34 being the conductive-resin layer, a conductive-resin paste including a thermosetting resin and a metal component is applied, in step S7, onto the first end surface 12e and the second end surface 12f of the multilayer body 12. Subsequently, the conductive-resin paste is heat-treated to form the conductive-resin layer.

In the case of the base-electrode layer 134 being the direct plating layer as in the second example embodiment, plating is performed on the first end surface 112e and the second end surface 112f of the multilayer body 112 in step S7. It is preferable to use, for example, electrolytic plating. It is also preferable to use barrel plating, for example.

In the case of the first surface electrodes 118 being formed on the first principal surface 112a of the multilayer body 112 as in the second example embodiment, the dielectric sheet on which the pattern of the first surface electrodes 118 is printed may be laminated as the outermost layer in step S3 to form the multilayer block for the first outer-layer portion having the first surface electrodes 118. Similarly, in the case of the second surface electrodes 119 being formed on the second principal surface 112b of the multilayer body 112, the dielectric sheet on which the pattern of the first surface electrodes 118 is printed may be laminated as the outermost layer in step S3 to form the multilayer block for the second outer-layer portion having the second surface electrodes 119. In this case, the first surface electrodes 118 and the second surface electrodes 119 are similar in roughness, thickness, and denseness (i.e., coverage).

The example embodiments of the present invention have been described above. The example embodiments, however, are not intended to limit the scope of present invention. The example embodiments can be altered and modified in terms of mechanism, shape, material, quantity, position, arrangement, or the like without departing from the scope of the present invention, and such alterations and modifications are to be included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first principal surface and a second principal surface opposed to each other in a lamination direction, a first side surface and a second side surface opposed to each other in a width direction that orthogonally or substantially orthogonally intersects the lamination direction, and a first end surface and a second end surface opposed to each other in a length direction that orthogonally or substantially orthogonally intersects the lamination direction and the width direction; and
at least two outer electrodes on at least two surfaces of the multilayer body; wherein
a length of the multilayer body in the length direction is greater than a width of the multilayer body in the width direction;
the multilayer body includes:
an inner-layer portion; and
two outer-layer portions between which the inner-layer portion is interposed in the lamination direction;
the inner-layer portion includes:
a plurality of first dielectric layers laminated in the lamination direction; and
a first inner electrode between two of the plurality of first dielectric layers and exposed at at least one of the first end surface and the second end surface;
each outer-layer portion includes:
at least one second dielectric layer; and
a second inner electrode in contact with the at least one second dielectric layer and exposed at at least one of the first end surface and the second end surface;
a length of the second inner electrode in the length direction is less than a length of the first inner electrode in the length direction; and
when each outer-layer portion is divided into two equal regions in the lamination direction, a porosity of a region near the inner-layer portion is less than a porosity of a region farther from the inner-layer portion.

2. The multilayer ceramic capacitor according to claim 1, wherein, when a first outer-layer portion denotes one of the two outer-layer portions that is closer to the first principal surface and a second outer-layer portion denotes one of the two outer-layer portion that is closer to the second principal surface, a height of the second outer-layer portion in the lamination direction is greater than a height of the first outer-layer portion in the lamination direction.

3. The multilayer ceramic capacitor according to claim 1, wherein, when a first outer-layer portion denotes one of the two outer-layer portions that is closer to the first principal surface and a second outer-layer portion denotes one of the two outer-layer portion that is closer to the second principal surface, the length of the second inner electrode in the first outer-layer portion in the length direction is greater than the length of the second inner electrode in the second outer-layer portion in the length direction.

4. A multilayer ceramic capacitor comprising:
a multilayer body including a first principal surface and a second principal surface opposed to each other in a lamination direction, a first side surface and a second side surface opposed to each other in a width direction that orthogonally or substantially orthogonally intersects the lamination direction, and a first end surface and a second end surface opposed to each other in a length direction that orthogonally or substantially orthogonally intersects the lamination direction and the width direction; and
at least two outer electrodes on at least two surfaces of the multilayer body; wherein
a width of the multilayer body in the width direction is greater than a length of the multilayer body in the length direction;
the multilayer body includes:
an inner-layer portion; and
two outer-layer portions between which the inner-layer portion is interposed in the lamination direction;
the inner-layer portion includes:
a plurality of first dielectric layers laminated in the lamination direction; and
a first inner electrode between two of the plurality of first dielectric layers and exposed at at least one of the first end surface and the second end surface;
each outer-layer portion includes:
at least one second dielectric layer; and
a second inner electrode in contact with the at least one second dielectric layer and exposed at at least one of the first end surface and the second end surface;
a length of the second inner electrode in the length direction is less than a length of the first inner electrode in the length direction; and
when each outer-layer portion is divided into two equal regions in the lamination direction, a porosity of a region near the inner-layer portion is less than a porosity of a region farther from the inner-layer portion.

5. The multilayer ceramic capacitor according to claim 4, wherein, when a first outer-layer portion denotes one of the two outer-layer portions that is closer to the first principal surface and a second outer-layer portion denotes one of the two outer-layer portion that is closer to the second principal surface, a height of the second outer-layer portion in the lamination direction is greater than a height of the first outer-layer portion in the lamination direction.

6. The multilayer ceramic capacitor according to claim 4, wherein, when a first outer-layer portion denotes one of the two outer-layer portions that is closer to the first principal surface and a second outer-layer portion denotes one of the two outer-layer portion that is closer to the second principal surface, the length of the second inner electrode in the first outer-layer portion in the length direction is greater than the length of the second inner electrode in the second outer-layer portion in the length direction.

7. A multilayer ceramic capacitor comprising:
a multilayer body including a first principal surface and a second principal surface opposed to each other in a lamination direction, a first side surface and a second side surface opposed to each other in a width direction that orthogonally or substantially orthogonally intersects the lamination direction, and a first end surface and a second end surface opposed to each other in a length direction that orthogonally or substantially orthogonally intersects the lamination direction and the width direction; and
four outer electrodes on corner region of the multilayer body; wherein
a ratio W/L which is a ratio of the width W to the length of the multilayer ceramic capacitor is about 0.85 or more and about 1.0 or less;
the multilayer body includes:
an inner-layer portion; and
two outer-layer portions between which the inner-layer portion is interposed in the lamination direction;
the inner-layer portion includes:
a plurality of first dielectric layers laminated in the lamination direction; and
a first inner electrode between two of the plurality of first dielectric layers and exposed at at least one of the first end surface and the second end surface;
each outer-layer portion includes:
at least one second dielectric layer; and
a second inner electrode in contact with the at least one second dielectric layer and exposed at at least one of the first end surface and the second end surface;
a length of the second inner electrode in the length direction is less than a length of the first inner electrode in the length direction; and
when each outer-layer portion is divided into two equal regions in the lamination direction, a porosity of a region near the inner-layer portion is less than a porosity of a region farther from the inner-layer portion.

8. The multilayer ceramic capacitor according to claim 7, wherein, when a first outer-layer portion denotes one of the two outer-layer portions that is closer to the first principal surface and a second outer-layer portion denotes one of the two outer-layer portion that is closer to the second principal surface, a height of the second outer-layer portion in the lamination direction is greater than a height of the first outer-layer portion in the lamination direction.

9. The multilayer ceramic capacitor according to claim 7, wherein, when a first outer-layer portion denotes one of the two outer-layer portions that is closer to the first principal surface and a second outer-layer portion denotes one of the two outer-layer portion that is closer to the second principal surface, the length of the second inner electrode in the first outer-layer portion in the length direction is greater than the length of the second inner electrode in the second outer-layer portion in the length direction.

10. The multilayer ceramic capacitor according to claim 7, wherein a width of the second inner electrode in the width direction is less than a width of the first inner electrode in the width direction.

11. The multilayer ceramic capacitor according to claim 7, wherein the multilayer ceramic capacitor includes a first surface electrode.

12. The multilayer ceramic capacitor according to claim 11, wherein the multilayer ceramic capacitor includes a second surface electrode.

13. The multilayer ceramic capacitor according to claim 11, wherein the first surface electrode and the second internal electrode have a same or substantially a same shape.

14. The multilayer ceramic capacitor according to claim 12, wherein the second surface electrode and the second internal electrode have a same or substantially a same shape.

15. The multilayer ceramic capacitor according to claim 11, wherein the first surface electrode and the second internal electrode have a same or substantially a same size.

16. The multilayer ceramic capacitor according to claim 12, wherein the second surface electrode and the second internal electrode have a same or substantially a same size.
